(19) United States
(12) Patent Application Publication
(10) Pub. No.: US 2025/0013945 A1
(43) Pub. Date: Jan. 9, 2025

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventor: Riki Eto, Tokyo (JP)

(73) Assignee: NEC Corporation, Minato-ku, Tokyo (JP)

(21) Appl. No.: 18/709,919

(22) PCT Filed: Nov. 29, 2021
(86) PCT No.: PCT/JP2021/043618

§ 371 Date: May 14, 2024

(51) Int. Cl. G06Q 10/0631; G06N 3/092; G06Q 10/04; G06Q 50/06

(52) U.S. Cl. CPC G06Q 10/0631; G06N 3/092; G06Q 10/04; G06Q 50/06

(57) ABSTRACT

In order to generate a more efficient operation plan as an operation plan regarding a water distribution plan, an information processing apparatus (1) includes: an acquisition means (11) for acquiring target data regarding a target water distribution plan; and a generation means (12) for generating an operation plan regarding the target water distribution plan by solving an optimization problem that uses (i) a cost function determined by inverse reinforcement learning which uses reference data regarding a reference water distribution plan and (ii) the target data acquired by the acquisition means.

### TECHNICAL FIELD

The present invention relates to a technique for generating an operation plan regarding a water distribution plan.

### BACKGROUND ART

Improvement in efficiency of a water distribution plan is required in a waterworks infrastructure, and a technique for optimization with use of a prediction model has conventionally been known. For example, Patent Literature 1 indicates that a draft operation plan for a water intake, conveyance, and distribution process of a waterworks plant is formed by solving an optimization problem in which a constraint condition concerning a configuration of a plant and an evaluation index are regarded as objective functions.

### CITATION LIST

### Patent Literature

### [Patent Literature 1]

Japanese Patent Application Publication Tokukai No. 2018-185678

### SUMMARY OF INVENTION

### Technical Problem

However, Patent Literature 1 does not disclose any specific method for calculating the evaluation index. Thus, the technique disclosed in Patent Literature 1 has a problem such that an operation plan is not necessarily optimized.

An example aspect of the present invention has been made in view of the above problem, and an example object thereof is to provide a technique that makes it possible to generate a more efficient operation plan as an operation plan regarding a water distribution plan.

### Solution to Problem

An information processing apparatus according to an example aspect of the present invention includes: an acquisition means for acquiring target data regarding a target water distribution plan; and a generation means for generating an operation plan regarding the target water distribution plan by solving an optimization problem that uses (i) a cost function determined by inverse reinforcement learning which uses reference data regarding a reference water distribution plan and (ii) the target data acquired by the acquisition means.

An information processing apparatus according to an example aspect of the present invention includes: an acquisition means for acquiring reference data regarding a reference water distribution plan; and a determination means for determining, by inverse reinforcement learning that refers to the reference data, a cost function which is used for an optimization problem for generating an operation plan regarding a target water distribution plan.

An information processing method according to an example aspect of the present invention includes: acquiring target data regarding a target water distribution plan; and generating an operation plan regarding the target water distribution plan by solving an optimization problem that uses (i) a cost function determined by inverse reinforcement learning which uses reference data regarding a reference water distribution plan and (ii) the target data acquired by the acquisition means.

An information processing method according to an example aspect of the present invention includes: acquiring reference data regarding a reference water distribution plan; and determining, by inverse reinforcement learning that refers to the reference data, a cost function which is used for an optimization problem for generating an operation plan regarding a target water distribution plan.

A program according to an example aspect of the present invention causes a computer to carry out: an acquisition process for acquiring target data regarding a target water distribution plan; and a generation process for generating an operation plan regarding the target water distribution plan by solving an optimization problem that uses (i) a cost function determined by inverse reinforcement learning which uses reference data regarding a reference water distribution plan and (ii) the target data acquired by the acquisition means.

A program according to an example aspect of the present invention causes a computer to carry out: an acquisition process for acquiring reference data regarding a reference water distribution plan; and a determination process for determining, by inverse reinforcement learning that refers to the reference data, a cost function which is used for an optimization problem for generating an operation plan regarding a target water distribution plan.

### Advantageous Effects of Invention

An example aspect of the present invention makes it possible to generate a more efficient operation plan as an operation plan regarding a water distribution plan.

### BRIEF DESCRIPTION OF DRAWINGS

FIG. 1 is a block diagram illustrating a configuration of an information processing apparatus according to a first example embodiment.

FIG. 2 is a flowchart showing a flow of an information processing method according to the first example embodiment.

FIG. 3 is a block diagram illustrating a configuration of an information processing apparatus according to the first example embodiment.

FIG. 4 is a flowchart showing a flow of an information processing method according to the first example embodiment.

FIG. 5 is a block diagram illustrating a configuration of an information processing apparatus according to a second example embodiment.

FIG. 6 is a diagram for describing a water distribution plan issue according to the second example embodiment.

FIG. 7 is a diagram illustrating an overview of a water distribution network according to the second example embodiment.

FIG. 8 is a diagram illustrating a specific example of a pump operation pattern according to the second example embodiment.

FIG. 9 is a diagram illustrating an example display in which the pump operation pattern according to the second example embodiment is output in association with a time axis.

FIG. 10 is a block diagram illustrating a configuration of a computer functioning as each of information processing apparatuses according to the respective example embodiments of the present invention.

### EXAMPLE EMBODIMENTS

### First Example Embodiment

The following description will discuss a first example embodiment of the present invention in detail with reference to the drawings. The present example embodiment is an embodiment serving as a basis for an example embodiment described later.

### <Configuration of Information Processing Apparatus 1>

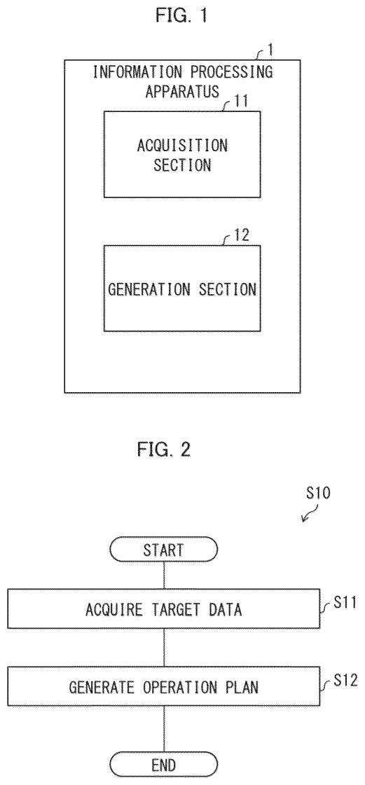

The following description will discuss a configuration of an information processing apparatus 1 according to the present example embodiment with reference to FIG. 1. FIG. 1 is a block diagram illustrating the configuration of the information processing apparatus 1. The information processing apparatus 1 is an apparatus that generates an operation plan regarding a target water distribution plan. A target for a water distribution plan is, for example, a waterworks infrastructure. The information processing apparatus 1 includes an acquisition section 11 and a generation section 12.

### (Acquisition Section 11)

The acquisition section 11 acquires target data regarding a target water distribution plan. The target data includes, for example, information indicative of a state of a target waterworks infrastructure. More specifically, the target data includes, for example, information pertaining to at least one selected from the group consisting of a pump, a water distribution network, a water pipeline, and a demand point in the target waterworks infrastructure. Note, however, that the target data is not limited to the above-described example, and may include other data regarding the target water distribution plan.

### (Generation Section 12)

The generation section 12 generates an operation plan regarding the target water distribution plan by solving an optimization problem that uses (i) a cost function determined by inverse reinforcement learning which uses reference data regarding a reference water distribution plan and (ii) the target data acquired by the acquisition section 11. Note here that the reference data is information pertaining to the reference water distribution plan. The reference data includes, for example, information indicative of a state of a reference waterworks infrastructure. More specifically, the reference data includes, for example, information pertaining to at least one selected from the group consisting of a pump, a water distribution network, a water pipeline, and a demand point in the reference waterworks infrastructure. Note here that the reference waterworks infrastructure may be identical to or different from a waterworks infrastructure for which an operation plan is to be generated.

Further, the reference data includes, for example, information pertaining to a pump operation pattern in the reference waterworks infrastructure. Furthermore, the reference data includes, for example, information pertaining to personnel involved in the reference waterworks infrastructure. Note, however, that the reference data is not limited to the above-described example, and may include other data regarding the reference water distribution plan.

Various types of data included in the target data and various types of data included in the reference data can also be referred to as state data indicative of a state in inverse reinforcement learning, or action data indicative of an action in inverse reinforcement learning. Note here that distinction between the state data and the action data can be changed as appropriate in accordance with problem setting. That is, at least some data included in the state data can also have a meaning as the action data. Further, at least some data included in the action data can also have a meaning as the state data.

The action data included in the reference data includes, for example, data indicative of an operation plan prepared by a skilled person regarding the reference waterworks infrastructure. More specifically, for example, the action data is represented by a variable(s) that is/are controlled on the basis of an operation rule, such as valve opening and closing, drawing in of water, and/or a pump threshold.

The operation plan generated by the generation section 12 includes, for example, information pertaining to a pump operation pattern in the target waterworks infrastructure.

Furthermore, the operation plan includes, for example, information pertaining to personnel involved in the target waterworks infrastructure. Note, however, that the operation plan is not limited to the above-described example, and may include other information.

The cost function includes, for example, cost terms including variables corresponding to respective items included in the reference data. In this case, the generation section 12 generates an operation plan regarding the target water distribution plan by solving an optimization problem which uses the cost function, in which the target data acquired by the acquisition section 11 is regarded as a fixed variable, and in which a variable that is among the variables included in the cost terms included in the cost function and that is different from the fixed variable is regarded as a manipulated variable. Note, however, that the cost function is not limited to the above-described example, and may be another function.

A method in which the generation section 12 solves the optimization problem is not particularly limited. For example, a solution may be found by carrying out a process equivalent to a common application program (e.g., IBM ILOG CPLEX, GurobiOptimizer, or SCIP).

As described above, in the information processing apparatus 1 according to the present example embodiment, a configuration is employed such that: target data regarding a target water distribution plan is acquired; and an operation plan regarding the target water distribution plan is generated by solving an optimization problem that uses (i) a cost function determined by inverse reinforcement learning which uses reference data regarding a reference water distribution plan and (ii) the acquired target data. Thus, the information processing apparatus 1 according to the present example embodiment brings about an effect of making it possible to generate a more efficient operation plan as an operation plan regarding a water distribution plan.

### <Flow of Information Processing Method S10>

The following description will discuss a flow of an information processing method S10 according to the present example embodiment with reference to FIG. 2. FIG. 2 is a flowchart showing the flow of the information processing method S10. In a step S11, the acquisition section 11 acquires target data regarding a target water distribution plan. In a step S12, the generation section 12 generates an operation plan regarding the target water distribution plan by solving an optimization problem that uses (i) a cost function determined by inverse reinforcement learning which uses reference data regarding a reference water distribution plan and (ii) the target data acquired in the step S11.

As described above, in the information processing method S10 according to the present example embodiment, a configuration is employed such that: target data regarding a target water distribution plan is acquired; and an operation plan regarding the target water distribution plan is generated by solving an optimization problem that uses (i) a cost function determined by inverse reinforcement learning which uses reference data regarding a reference water distribution plan and (ii) the acquired target data. Thus, the information processing method S10 according to the present example embodiment brings about an effect of making it possible to generate a more efficient operation plan as an operation plan regarding a water distribution plan.

### <Configuration of Information Processing Apparatus 2>

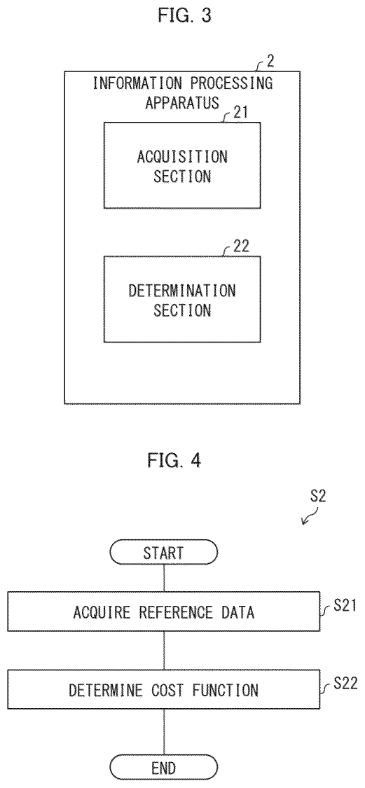

The following description will discuss a configuration of an information processing apparatus 2 according to the present example embodiment with reference to FIG. 3. FIG. 3 is a block diagram illustrating the configuration of the information processing apparatus 2. The information processing apparatus 2 is an apparatus that determines a cost function which is used for an optimization problem for generating an operation plan regarding a water distribution plan. The information processing apparatus 2 includes an acquisition section 21 and a determination section 22.

### (Acquisition Section 21)

The acquisition section 21 acquires reference data regarding a reference water distribution plan. The acquisition section 21 may collectively acquire the reference data, or may sequentially acquire the reference data.

### (Determination Section 22)

The determination section 22 determines, by inverse reinforcement learning that refers to the reference data, a cost function which is used for an optimization problem for generating an operation plan regarding a target water distribution plan. Note here that the cost function includes, for example, cost terms including variables corresponding to respective items included in the reference data.

As described above, in the information processing apparatus 2 according to the present example embodiment, a configuration is employed such that: reference data regarding a reference water distribution plan is acquired; and a cost function which is used for an optimization problem for generating an operation plan regarding a target water distribution plan is determined by inverse reinforcement learning that refers to the reference data. Thus, the information processing apparatus 2 according to the present example embodiment brings about an effect of making it possible to determine a cost function that makes it possible to generate a more efficient operation plan as an operation plan regarding a water distribution plan.

### <Flow of Information Processing Method S2>

The following description will discuss a flow of an information processing method S2 according to the present example embodiment with reference to FIG. 4. FIG. 4 is a flowchart illustrating the flow of the information processing method S2. In a step S21, the acquisition section 21 acquires reference data regarding a reference water distribution plan. The determination section 22 determines, by inverse reinforcement learning that refers to the reference data, a cost function which is used for an optimization problem for generating an operation plan regarding a target water distribution plan.

As described above, in the information processing method S2 according to the present example embodiment, a configuration is employed such that: reference data regarding a reference water distribution plan is acquired; and a cost function which is used for an optimization problem for generating an operation plan regarding a target water distribution plan is determined by inverse reinforcement learning that refers to the reference data. Thus, the information processing method S2 according to the present example embodiment brings about an effect of making it possible to determine a cost function that makes it possible to generate a more efficient operation plan as an operation plan regarding a water distribution plan.

### Second Example Embodiment

The following description will discuss a second example embodiment of the present invention in detail with reference to the drawings. Note that members having functions identical to those of the respective members described in the first example embodiment are given respective identical reference numerals, and a description of those members is not repeated.

### <Configuration of Information Processing Apparatus 1A>

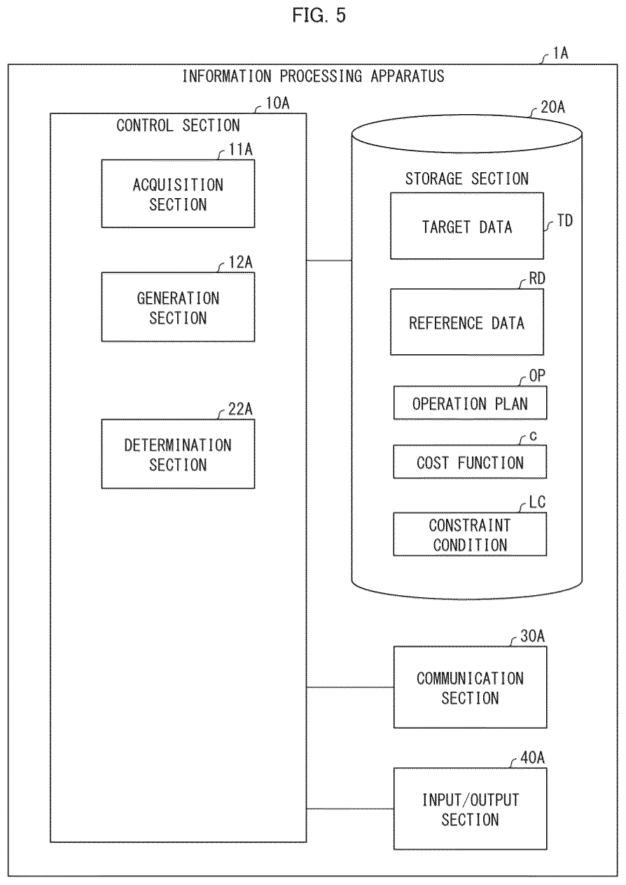

FIG. 5 is a block diagram illustrating a configuration of an information processing apparatus 1A according to the present example embodiment. The information processing apparatus 1A generates an operation plan regarding a water distribution plan for a waterworks infrastructure. The waterworks infrastructure according to the present example embodiment includes, for example, a plurality of locations such as a reservoir, a distributing reservoir, a water intake facility, a water purification plant, a water supply station, and a demand point. The operation plan includes, for example, information indicative of a pump operation pattern at each location. The information processing apparatus 1A includes a control section 10A, a storage section 20A, a communication section 30A, and an input/output section 40A.

### (Communication Section 30A)

The communication section 30A communicates, via a communication line, with an apparatus external to the information processing apparatus 1A. A specific configuration of the communication line is not limited to the present example embodiment. Examples of the communication line include a wireless local area network (LAN), a wired LAN, a wide area network (WAN), a public network, a mobile data communication network, and a combination thereof. The communication section 30A transmits, to another apparatus, data supplied from the control section 10A, and supplies, to the control section 10A, data received from another apparatus.

### (Input/Output Section 40A)

To the input/output section 40A, an input/output apparatus(es) such as a keyboard, a mouse, a display, a printer, and/or a touch panel is/are connected. The input/output section 40A receives, from an input apparatus(es) connected thereto, an input of various pieces of information to the information processing apparatus 1A. The input/output section 40A outputs, to an output apparatus(es) connected thereto, various pieces of information under control by the control section 10A. Examples of the input/output section 40A include an interface such as a universal serial bus (USB).

### (Control Section 10A)

The control section 10A includes an acquisition section 11A, a generation section 12A, and a determination section 22A as illustrated in FIG. 5.

### (Acquisition Section 11A)

The acquisition section 11A acquires target data TD and reference data RD. For example, the acquisition section 11A acquires the target data TD and the reference data RD from another apparatus via the communication section 30A. Further, for example, the acquisition section 11 may acquire the target data TD and the reference data RD that are input via the input/output section 40A. Furthermore, the acquisition section 11 may acquire the target data TD and the reference data RD by reading the target data TD and the reference data RD from the storage section 20A or an externally connected storage apparatus. Details of the target data TD and the reference data RD will be described later.

### (Generation Section 12A)

The generation section 12A generates an operation plan OP regarding the target water distribution plan by solving an optimization problem that uses (i) a cost function c determined by inverse reinforcement learning which uses reference data RD regarding a reference water distribution plan and (ii) the target data TD acquired by the acquisition section 11. A process carried out by the generation section 12A for generating the operation plan OP will be described later.

### (Determination Section 22A)

The determination section 22A determines, by inverse reinforcement learning that refers to the reference data RD, a cost function c which is used for an optimization problem for generating an operation plan OP regarding a target water distribution plan. A process carried out by the determination section 22A for determining the cost function c will be described later.

### (Storage Section 20A)

The storage section 20A stores the target data TD and the reference data RD that are acquired by the acquisition section 11. Further, the storage section 20A stores the operation plan OP generated by the generation section 12A. Furthermore, the storage section 20A stores the cost function c determined by the determination section 22A, and a constraint condition LC. Note here that the cost function c storing in the storage section 20A means that a parameter which defines the cost function c is stored in the storage section 20A.

### (Target Data TD)

The target data TD is data that the generation section 12A uses to generate the operation plan OP. The target data TD includes information indicative of a state of a target waterworks infrastructure. For example, the target data TD includes information pertaining to at least one selected from the group consisting of a pump, a water distribution network, a water pipeline, and a demand point in the target waterworks infrastructure.

More specifically, the target data TD includes, for example, at least one piece of data among the following (i) to (x) in the waterworks infrastructure, for which the operation plan is to be generated. Note, however, that data included in the target data TD is not limited to these, and may include other data.

(i) electric power consumption at each location, (ii) a demand forecast margin, (iii) a distributing reservoir margin, (iv) a water distribution loss, (v) the number of personnel in operation at each location, (vi) an electric power charge at each location, (vii) a voltage at each location, (viii) a water level at each location, (ix) a water pressure at each location, and (x) an amount of water at each location.

(i) The electric power consumption at each location refers to electric power consumption at each location such as a water purification plant or a water supply station. (ii) The demand forecast margin refers to a degree to which supply exceeds demand. (iii) The distributing reservoir margin refers to a degree to which a design water storage amount in the distributing reservoir exceeds an actual water storage amount. (iv) The water distribution loss refers to a degree to which it is impossible to distribute water to each demand point. (v) The number of personnel in operation refers to the number of personnel in operation at each location.

### (Reference Data RD)

The reference data RD is data that the determination section 22A uses to determine the cost function. The reference data RD includes information indicative of a state of a reference waterworks infrastructure. Note here that the reference waterworks infrastructure may be identical to or different from a waterworks infrastructure for which an operation plan is to be generated. More specifically, the reference data RD includes, for example, information pertaining to at least one selected from the group consisting of a pump, a water distribution network, a water pipeline, and a demand point in the reference waterworks infrastructure. Further, the reference data RD includes, for example, information pertaining to at least one selected from the group consisting of a pump operation pattern and personnel in the reference waterworks infrastructure. Each item included in the reference data RD may be treated as state data, or may be treated as action data.

More specifically, the reference data RD includes, for example, at least one piece of data among the following (i) to (x) in the reference waterworks infrastructure. Note, however, that data included in the reference data RD is not limited to these, and may include other data.

(i) electric power consumption at each location, (ii) a demand forecast margin, (iii) a distributing reservoir margin, (iv) a water distribution loss, (v) the number of personnel in operation at each location, (vi) an electric power charge at each location, (vii) a voltage at each location, (viii) a water level at each location, (ix) a water pressure at each location, and (x) an amount of water at each location.

Further, the reference data RD includes, for example, data indicative of an operation plan prepared by a skilled person regarding the reference waterworks infrastructure. More specifically, for example, the reference data RD includes data represented by a variable(s) that is/are controlled on the basis of an operation rule, such as valve opening and closing, drawing in of water, and/or a pump threshold. Such data can be said to be data indicative of a history of decision making by, for example, a skilled person who has prepared a reference operation plan (an intention of the skilled person).

### (Operation Plan OP)

The operation plan OP includes, for example, information pertaining to a pump operation pattern in the target waterworks infrastructure. Furthermore, the operation plan OP includes, for example, information pertaining to personnel involved in the target waterworks infrastructure.

### (Cost Function c)

The cost function c includes cost terms including variables corresponding to respective items included in the reference data RD. The cost function c can be represented by, for example, the following:

$$c ( \{ {x}_{i} \} ) = {\sum }_{i} {α}_{i} \cdot {f}_{i} ( {x}_{i} )$$

where i is i [N], and N is a total number of items included in the reference data. A cost term αᵢ·fᵢ(xᵢ) includes a variable xᵢ corresponding to an item rᵢ included in the reference data. A weighting factor αᵢ is a weighting factor for each item rᵢ. In other words, a cost function c({xᵢ}) is a linear sum of the cost term αᵢ·fᵢ(xᵢ) obtained by multiplying the weighting factor αᵢ corresponding to the item ri and a function f(xᵢ) including the variable xᵢ.

### (Constraint Condition LC)

The constraint condition LC is a constraint condition of an optimization problem solved by the generation section 12A. The constraint condition LC includes, for example, the following (i) to (iv). Note that the constraint condition LC is not limited to these, and may include other conditions.

(i) The reservoir/distributing reservoir has a water storage amount that is not less than a threshold X and less than Y.
(ii) A supply amount is at least X % above a demand amount.
(iii) Water can be distributed to all demand points.
(iv) A route under construction is not used.

### <Process Carried Out by Generation Section 12A>

The generation section 12A generates the operation plan OP regarding the target water distribution plan by solving, under the constraint condition LC, an optimization problem that uses the cost function c and the target data TD. In the present example embodiment, the generation section 12A generates an operation plan OP regarding the target water distribution plan by solving an optimization problem which uses the cost function c, in which the target data TD acquired by the acquisition section 11A is regarded as a fixed variable, and in which a variable that is among the variables included in the cost terms included in the cost function c and that is different from the fixed variable is regarded as a manipulated variable.

Further, the generation section 12A outputs the generated operation plan OP. The generation section 12A may output the operation plan OP by writing the operation plan OP to the storage section 20A or an external storage apparatus, or may output the operation plan OP to an output apparatus(es) (a display, a printer, and/or the like) connected to the input/output section 40A. Furthermore, the generation section 12A may transmit the operation plan OP to another apparatus via the communication section 30A.

### <Process Carried Out by Determination Section 22A>

The determination section 22A determines, by inverse reinforcement learning that refers to the reference data RD, a cost function c which is used for an optimization problem for generating an operation plan regarding a target water distribution plan. For example, the determination section 22A determines, by inverse reinforcement learning that uses the state data and the action data which are included in the reference data RD, the weighting factor αᵢ of the cost term αᵢ·fᵢ(xᵢ) included in the cost function c. For example, the determination section 22A prepares cost functions c in which values of respective weighting factors αᵢ are diverse, and uses the cost functions to calculate cost regarding the reference data RD. Then, the determination section 22A determines the values of the respective weighting factors αᵢ such that the cost regarding the reference data RD is the smallest.

As another example, the determination section 22A may be configured to determine the cost function c by an inverse reinforcement learning method disclosed in the patent literature, which is the International Publication No. WO2021/130916. Note, however, a method in which the determination section 22A determines the cost function c is not limited to this, and may be another method.

Further, the determination section 22A outputs the determined cost function c. The determination section 22A may output the cost function c by writing the cost function c to the storage section 20A or an external storage apparatus, or may output the cost function c to an output apparatus(es) (a display, a printer, and/or the like) connected to the input/output section 40A. Furthermore, the generation section 12A may transmit the cost function c to another apparatus via the communication section 30A.

### <Setting of Optimization Problem>

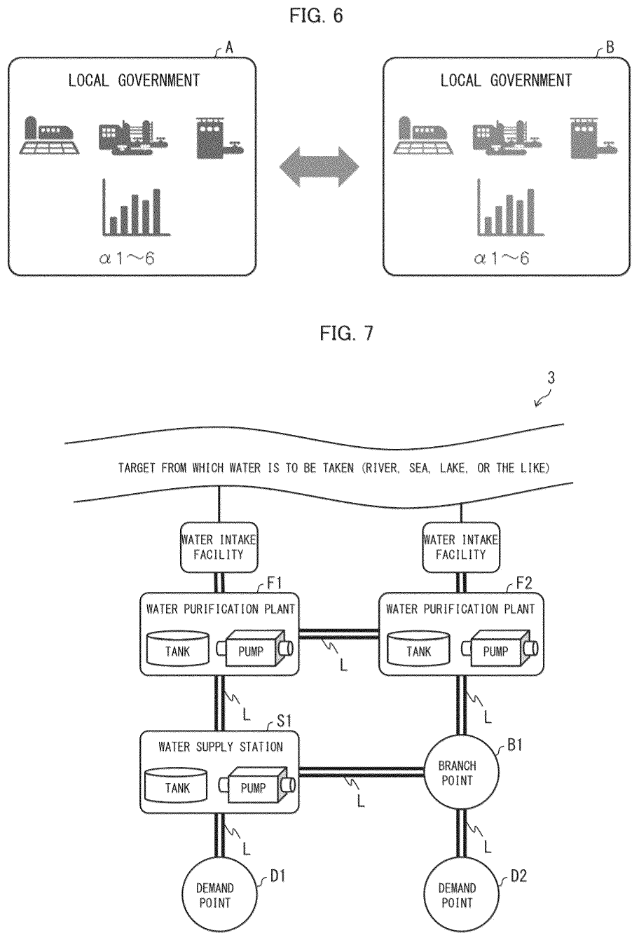

FIG. 6 is a diagram for describing a specific example of setting of an optimization problem according to the present example embodiment. The operation plan OP needs to be determined in consideration of various viewpoints, such as how much margin is left from forecasted demand, to what extent electric power consumption is minimized, and to what degree a water level in a distributing reservoir is considered. It is difficult to set weighting of these viewpoints. This is because to what degree a corresponding viewpoint is emphasized varies depends on, for example, an operator that operates the waterworks infrastructure, and is not uniformly determined. For example, there is a case where a local government A, which is a generator of a certain operation plan, emphasizes the viewpoint of electric power consumption, whereas a local government B emphasizes the water level in the distributing reservoir.

In the present example embodiment, the generation section 12A solves, under the constraint condition LC, the optimization problem that uses the target data TD and the cost function c determined by inverse reinforcement learning in which the weighting factor αᵢ of each cost term αᵢ·fᵢ(xᵢ) refers to the reference data RD. Note here that the weighting factor αᵢ of the each cost term αᵢ·fᵢ(xᵢ) included in the cost function c is determined by inverse reinforcement learning that refers to the reference data RD. Thus, the weighting factor αᵢ has a value in which the action data included in the reference data RD is reflected, that is, a value in which an intention of, for example, a skilled person who has generated a reference operation plan is reflected. By using the cost function c including such a weighting factor αᵢ to solve the optimization problem, it is possible to generate an operation plan in which an intention of, for example, a skilled person who has generated a reference operation plan is reflected.

For example, in the example of FIG. 6, weighting factors α1 to α6 included in the cost function c to be used to generate the operation plan OP of the local government A are values in which an intention of, for example, a skilled person who has generated a reference operation plan used to determine the cost function c is reflected. Further, weighting factors α1 to α6 included in the cost function c to be used to generate the operation plan OP of the local government B are values in which an intention of, for example, a skilled person who has generated a reference operation plan used to determine the cost function c is reflected. Comparing the weighting factors of local government A with the weighting factors of local government B makes it easier to understand what viewpoint each of the local governments emphasizes.

Further, for example, the determination section 22A can determine the cost function c with reference to the reference data RD including an operation plan prepared by a skilled person α1 in the local government A, and the generation section 12A can use the cost function c determined by the determination section 22A and the target data TD of the local government A to generate a future operation plan OP. In this case, the generation section 12A can generate the future operation plan OP for the local government A in which future operation plan an intention of the skilled person α1 is reflected.

The present example embodiment makes it possible to reflect, in an operation plan of another local government, an intention of a generator of an operation plan in a certain local government. For example, the determination section 22A can determine the cost function c with reference to the reference data RD including an operation plan prepared by the skilled person α1 in the local government A, and the generation section 12A can use the cost function c determined by the determination section 22A and the target data TD of the local government B to generate a future operation plan OP. In this case, the generation section 12A can generate the operation plan OP for the local government B in which operation plan an intention of the skilled person α1 is reflected.

### First Specific Example of Optimization of Operation Plan

The following description will discuss, with reference to FIGS. 7 to 9, a specific example of optimization of an operation plan regarding a pump in a waterworks infrastructure.

### (Overview of Water Distribution Network 3)

FIG. 7 is a diagram illustrating an overview of a water distribution network 3, which is an example of a target for which the operation plan OP is to be generated by the information processing apparatus 1A. The water distribution network 3 includes a plurality of locations, which are water purification plants F1 and F2, a water supply station S1, a branch point B1, and demand points D1 and D2. The water purification plants F1 and F2 are each, for example, a facility that generates clean water from water which a water intake facility has taken from a target from which water is to be taken (a river, the sea, a lake, or the like). In each of the water purification plants F1 and F2, a water storage facility (a tank, a reservoir, or the like) and a pump are provided. The water supply station S1 is, for example, a facility that distributes, to a specific area, water sent from, for example, the water purification plants F1, F2, and the like. In the water supply station S1, for example, a water storage facility (a tank, a reservoir, or the like) and a pump are provided. The demand points D1 and D2 are each a facility of a consumer (e.g., an office, a household, a factory, or a store) that uses distributed water. The branch point B1 is a facility that branches a water pipeline L. Components (locations) of the water distribution network 3 are connected by water pipelines L.

In the example of FIG. 7, a plurality of water purification plants F1 and F2, a single water supply station S1, a single branch point B1, and a plurality of demand points D1 and D2 are illustrated. Note, however, that the number of water purification plants included in the water distribution network, the number of water supply stations included in the water distribution network, and the number of branch points included in the water distribution network, and the number of demand points included in the water distribution network are not limited to the example of FIG. 7, and may be larger or smaller than those in the example of FIG. 7.

### Specific Example of Explanatory Variable

The following description will discuss a specific example of an explanatory variable that is used to optimize an operation plan related to the above-described water distribution network 3. Note, however, that data used to optimize an operation plan in a waterworks infrastructure is not limited to data shown below. It is possible to use (i) any information that makes it possible to define a state of the waterworks infrastructure and (ii) any variable that can be controlled on the basis of an operation rule of the waterworks infrastructure.

### First Example of Explanatory Variable: Information Pertaining to Pump

The explanatory variable includes, for example, information pertaining to a pump provided at each location. Examples of the information pertaining to the pump include (i) a combination of pumps that move at a certain timing (or time interval), (ii) a water flow rate, and (iii) electric power consumption.

As (i) the combination of pumps that operate at a certain timing (or time interval), for example, a case is assumed where two pumps (tentatively referred to as pumps P1 and P2) are provided in a certain facility. Assuming that a pump operation pattern in this case is “1”, “1” includes three patterns, which are “{P1}” (only P1 operates), “{P2}” (only P2 operates), and “{P1, P2}” (P1 and P2 operate), and each of the patterns is expressed as “1=1, 2, 3”.

(ii) The water flow rate is an amount of output water (flow rate of water) from the pump(s) in each of the operation patterns. (iii) The electric power consumption is an amount of electric power (electric power consumption) used by each of the pumps.

### Second Example of Explanatory Variable: Information Pertaining to Water Distribution Network 3

Further, the explanatory variable includes, for example, information pertaining to the water distribution network 3. Assume, for example, that a set of nodes of facilities (assumed to be “n” places) constituting the water distribution network 3 is V (V={1, 2, . . . , n}). In a case where a set of nodes of a water purification plant is referred to as “F”, a set of nodes of a water supply station is referred to as “S”, a set of nodes of a branch point is referred to as “B”, and a set of nodes of a demand point is referred to as “D”, the following equation is established.

V=F∪S∪B↑D

Furthermore, assuming that the water purification plants F1 and F2 and the water supply station S1 are present in total in “K” places, a set of nodes of these is represented as follows.

F∪S={1,2, . . . ,K}

### Third Example of Explanatory Variable: Information Pertaining to Water Pipeline L

Further, the explanatory variable includes, for example, information pertaining to the water pipelines L. For example, identification information that makes it possible to distinguish between the water pipelines L is assigned to each of the water pipelines L and is expressed as a feature. More specifically, numbers that make it possible to distinguish between the water pipelines L, for example, from “1” to “m”, are assigned to the respective water pipelines L. Furthermore, for example, the feature of each of the water pipelines L is represented by a flow rate “qᵢ(t) [m³/15 min]” of water flowing through a water pipeline L with the number “i” at a time interval “t” (“t=1, . . . , T”).

### Fourth Example of Explanatory Variable: Information Pertaining to Demand Point D

Further, the explanatory variable may also include information pertaining to the demand point D. The information pertaining to the demand point D is, for example, a predicted value of a demand amount of each demand point at a certain timing (for example, a time or a time interval). The demand amount “dᵢ(t)” of a demand point “dᵢ(i D)”, included in a set D of nodes of the demand point, at the time interval “t” is represented by the following equation.

Demand amount: dᵢ(t)

i∈D,t=1, . . . , T

### Fifth Example of Explanatory Variable: Actually Executed Pump Operation Pattern

Further, the explanatory variable may include, for example, an actual operating state of a pump operation pattern. In this case, the explanatory variable refers to, for example, a pump that operates at a certain timing (or time interval). In a case where there are “Lk” patterns as the pump operation pattern “1” in a certain facility (water purification plant F or water supply station S), an operation state of the pump operation pattern at the time interval “t” is formulated as the following expression P (t).

Pump operation pattern: P_{k,l}(t)∈{0,1}

where t=1, . . . T, k∈F∪S, l=1, . . . Lₖ

### Sixth Example of Explanatory Variable: Information Pertaining to Personnel

Further, the explanatory variable includes, for example, information pertaining to personnel assigned at respective locations included in the water distribution network 3. The information pertaining to the personnel may be, for example, any data that is expressed as a feature, such as information such as the number of persons assigned, a type of job (either a clerical job or a technical job) of each person, and/or service years. Alternatively, the data may be a work shift of an employee at each node.

### Output Example

Next, the following description will discuss a specific example of output from the information processing apparatus 1A with reference to the drawings. For example, the information processing apparatus 1A displays the generated operation plan OP on a display (not illustrated) connected to an input/output section 50A.

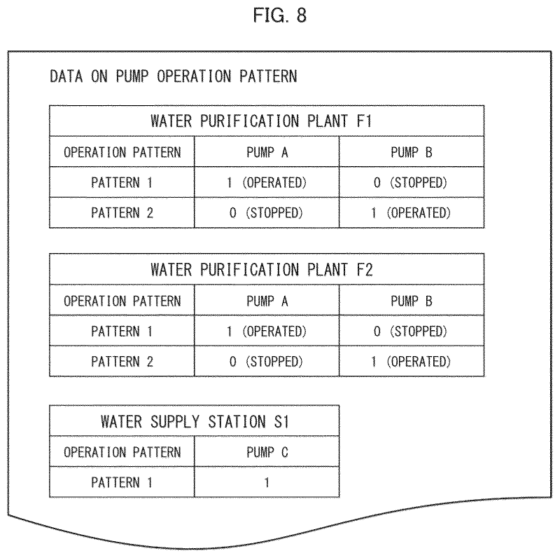

FIG. 8 is a diagram illustrating a specific example of a pump operation pattern included in the operation plan OP. In the example of FIG. 8, two pumps (pump A and pump B) are provided in each of the water purification plant F1 and the water purification plant F2. One pump (pump C) is provided in the water supply station S1. For example, the pump A and the pump C each may be a small-sized pump, and the pump B may be a large-sized pump (a larger-sized pump than the pump A and the pump C). In the example of FIG. 8, “pattern 1” at the water purification plant F1 refers to a pattern in which only the pump A is operated, and “operation pattern 2” refers to a pattern in which only the pump B is operated. Same applies to the water purification plant F2. “Pattern 1” in the water supply station S1 refers to a pattern in which only the pump C is operated.

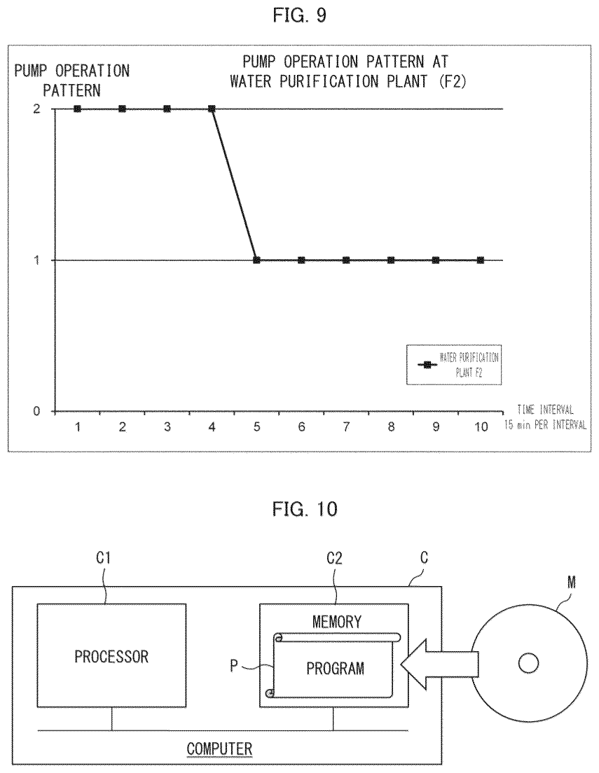

The information processing apparatus 1A can output the operation plan OP by outputting, in association with a time axis, the pump operation pattern illustrated in FIG. 8. FIG. 9 is a diagram illustrating a display example in which the pump operation pattern is output in association with the time axis. In a graph of FIG. 9, a horizontal axis shows a time interval, and a vertical axis shows the pump operation pattern. The graph of FIG. 9 shows an operation plan in which the pump operation pattern is changed from the operation pattern 2 to the operation pattern 1 at a time interval 5.

### Example Application to Downsizing

The following description will discuss application to downsizing as an example application of the present example embodiment. In a region in which a decrease in population is predicted, improvement in efficiency of waterworks is required. A water pipe requires large-scale maintenance on a regular basis, and merely possessing the water pipe incurs cost. This causes a problem of addition of the cost to a water charge with a resulting increase in water charge. Thus, downsizing is required in, for example, a region in which a decrease in population is predicted.

Downsizing requires an operation to predict the future and consider which facility to leave and which facility to disuse, and consequently requires much effort. Furthermore, a budget and an operation method for a waterworks project considerably vary from local government to local government, and there is a problem such that a conventionally-used simple prediction model is insufficient to deal with the budget and the operation method.

Examples of an example application of downsizing include (i) an example in which an operation plan of a certain local government A is operated in a target local government B in which waterworks have been downsized and (ii) an example in which an intention is extracted from a downsizing execution plan of the local government A, and a downsizing plan of the target local government B is drafted.

In this case, the state data includes, for example, (a) an index indicating a state of a waterworks infrastructure, (b) a state of a water distribution network, a state of a capacity of a pump, and a state of a drain pipe, and (c) a voltage, a water level, a pressure, and an amount of water at each location. For example, the action data is represented by a variable(s) that can be controlled on the basis of an operation rule, such as valve opening and closing, drawing in of water, and/or a pump threshold.

Further, the reference data includes, for example, (a) information pertaining to a water pipe and a water quality, (b) information pertaining to a water purification plant, (c) demographics, (d) staff information of a waterworks bureau, and (e) action data of a skilled person. Note here that examples of (a) the information pertaining to the water pipe and the water quality include a water quality of a water source (the water source containing a large amount of arsenic, iron, manganese, and/or the like incurs water purification cost), the number of water sources, and an elevation of a water source; a place at which a water pipeline is laid, the number of users of the water pipeline for each region; and population supplied with water per 1 km of the water pipeline.

Examples of (b) the information pertaining to the water purification plant include what amount of water the water purification plant produces per day, a ratio of a water purification amount of the water purification plant to a total water purification amount, an annual production cost, and annual electric power consumption.

Examples of (c) the demographics include a population transition in a 500 m×500 m square and a predicted value of the population transition. Examples of (d) the staff information of the waterworks bureau include the number of clerical staff and technical staff (which may include skilled nonclerical staff, meter reading staff, and contract staff).

Examples of (e) the action data of a skilled person or the like include a facility consolidation/renewal plan (the number of water purification plants and positions at which to provide the water purification plants), population supplied with water per 1 km of the water pipeline, and the number of staff assigned. The action data indicates, for example, that, in a case where there are three water purification plants, A, B, and C and ratios of water purification amounts of the water purification plants A, B, and C to the current total water purification amount are 50%, 20%, and 30%, respectively, the ratios are changed to 30%, 10%, and 60%, respectively.

### Example Use of Result of Intention Extraction

The information processing apparatus 1A may present a consolidation plan in which a plurality of intentions are reflected. An intention of a creator of the reference water distribution plan is reflected in the cost function c determined by the determination section 22A. That is, in a case where the reference data RD varies, the cost function c determined by the determination section 22A also varies. For example, the generation section 12A uses a plurality of cost functions c to generate respective operation plans OP (consolidation plans), and presents the plurality of generated operation plans OP to a user. Further, in so doing, the generation section 12A may visualize and present a feature (a weighting factor of each of the cost functions c, etc.) of each of the operation plans OP.

Furthermore, in a case where the plurality of operation plan OPs are generated, the generation section 12A may present the user with a charge simulator for each of the generated operation plans OP (for example, calculate a charge per 1,000 liters by calculating, for an operation plan, an aging water pipe renewal cost, a waterworks facility maintenance cost, a labor cost, revenues from waterworks, etc.).

Furthermore, the generation section 12A may display (i) an estimation of a household water consumption volume (population transition x water consumption volume per household) and (ii) an amount of water supplied by a generated operation plan in a display manner such that (i) and (ii) can be compared.

### Software Implementation Example

A part or all of the functions of each of the information processing apparatuses 1, 1A, and 2 may be realized by hardware such as an integrated circuit (IC chip) or may be alternatively realized by software.

In the latter case, the information processing apparatuses 1, 1A, and 2 are each realized by, for example, a computer that executes instructions of a program that is software realizing the functions. FIG. 10 illustrates an example of such a computer (hereinafter, referred to as “computer C”). The computer C includes at least one processor C1 and at least one memory C2. In the memory C2, a program P for causing the computer C to operate as each of the information processing apparatuses 1, 1A, and 2 is recorded. In the computer C, the functions of each of the information processing apparatuses 1, 1A, and 2 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

An information processing apparatus including:
an acquisition means for acquiring target data regarding a target water distribution plan; and
a generation means for generating an operation plan regarding the target water distribution plan by solving an optimization problem that uses
   (i) a cost function determined by inverse reinforcement learning which uses reference data regarding a reference water distribution plan and
   (ii) the target data acquired by the acquisition means.

The above configuration makes it possible to generate a more efficient operation plan as an operation plan regarding a water distribution plan.

### (Supplementary Note 2)

The information processing apparatus according to Supplementary Note 1, wherein
the cost function includes cost terms including variables corresponding to respective items included in the reference data, and
the generation means generates the operation plan regarding the target water distribution plan by solving the optimization problem which uses the cost function, in which the target data acquired by the acquisition means is regarded as a fixed variable, and in which a variable that is among the variables included in the cost terms included in the cost function and that is different from the fixed variable is regarded as a manipulated variable.

The above configuration makes it possible to generate a more efficient water distribution plan.

### (Supplementary Note 3)

The information processing apparatus according to Supplementary Note 1 or 2, wherein
the target data includes information indicative of a state of a target waterworks infrastructure.

The above configuration makes it possible to generate a more efficient operation plan regarding a waterworks infrastructure.

### (Supplementary Note 4)

The information processing apparatus according to Supplementary Note 3, wherein
the target data includes information pertaining to at least one selected from the group consisting of a pump, a water distribution network, a water pipeline, and a demand point in the target waterworks infrastructure.

According to the above configuration, concerning at least one selected from the group consisting of a pump, a water distribution network, a water pipeline, and a demand point in a waterworks infrastructure, it is possible to generate an operation plan in which an intention of a creator of an operation plan regarding reference data is reflected.

### (Supplementary Note 5)

The information processing apparatus according to Supplementary Note 3 or 4, wherein
the operation plan generated by the generation means includes information pertaining to an operation pattern of a pump in the target waterworks infrastructure.

The above configuration makes it possible to generate a more efficient pump operation pattern.

### (Supplementary Note 6)

The information processing apparatus according to any one of Supplementary notes 3 to 5, wherein
the operation plan generated by the generation means includes information pertaining to personnel involved in the target waterworks infrastructure.

The above configuration makes it possible to generate information that enables more efficient operation and that pertains to personnel involved in the target waterworks infrastructure.

### (Supplementary Note 7)

The information processing apparatus according to any one of Supplementary notes 1 to 6, wherein
the acquisition means acquires the reference data,
the information processing apparatus further including
a determination means for determining the cost function by inverse reinforcement learning that refers to the reference data.

The above configuration makes it possible to determine a cost function that makes it possible to generate a more efficient operation plan as an operation plan regarding a water distribution plan.

### (Supplementary Note 8)

The information processing apparatus according to Supplementary Note 7, wherein
the reference data includes
   information pertaining to at least one selected from the group consisting of a pump, a water distribution network, a water pipeline, and a demand point in a reference waterworks infrastructure, and
   information pertaining to at least one selected from the group consisting of an operation pattern of the pump and personnel in the reference waterworks infrastructure.

The above configuration makes it possible to determine a cost function in which an intention of a creator of an operation plan in accordance with information is reflected, the information including (i) information pertaining to at least one selected from the group consisting of a pump, a water distribution network, a water pipeline, and a demand point in a reference waterworks infrastructure, and (ii) information pertaining to at least one selected from the group consisting of an operation pattern of the pump and personnel in the reference waterworks infrastructure.

### (Supplementary Note 9)

An information processing apparatus including:
an acquisition means for acquiring reference data regarding a reference water distribution plan; and
a determination means for determining, by inverse reinforcement learning that refers to the reference data, a cost function which is used for an optimization problem for generating an operation plan regarding a target water distribution plan.

The above configuration makes it possible to determine a cost function that makes it possible to generate a more efficient water distribution plan.

### (Supplementary Note 10)

An information processing method including:
acquiring target data regarding a target water distribution plan; and
generating an operation plan regarding the target water distribution plan by solving an optimization problem that uses
   (i) a cost function determined by inverse reinforcement learning which uses reference data regarding a reference water distribution plan and
   (ii) the acquired target data.

The above information processing method brings about an effect similar to that brought about by the above-described information processing apparatus.

### (Supplementary Note 11)

An information processing method including:
acquiring reference data regarding a reference water distribution plan; and
determining, by inverse reinforcement learning that refers to the reference data, a cost function which is used for an optimization problem for generating an operation plan regarding a target water distribution plan.

The above information processing method brings about an effect similar to that brought about by the above-described information processing apparatus.

### (Supplementary Note 12)

A program for causing a computer to carry out:
an acquisition process for acquiring target data regarding a target water distribution plan; and
a generation process for generating an operation plan regarding the target water distribution plan by solving an optimization problem that uses
   (i) a cost function determined by inverse reinforcement learning which uses reference data regarding a reference water distribution plan and
   (ii) the target data acquired in the acquisition process.

The above configuration brings about an effect similar to that brought about by the above-described information processing apparatus.

### (Supplementary Note 13)

A program for causing a computer to carry out:
an acquisition process for acquiring reference data regarding a reference water distribution plan; and
a determination process for determining, by inverse reinforcement learning that refers to the reference data, a cost function which is used for an optimization problem for generating an operation plan regarding a target water distribution plan.

The above configuration brings about an effect similar to that brought about by the above-described information processing apparatus.

### [Additional Remark 3]

The whole or part of the example embodiments disclosed above further can also be expressed as follows.

An information processing apparatus including at least one processor, the at least one processor carrying out: an acquisition process for acquiring target data regarding a target water distribution plan; and a generation process for generating an operation plan regarding the target water distribution plan by solving an optimization problem that uses (i) a cost function determined by inverse reinforcement learning which uses reference data regarding a reference water distribution plan and (ii) the target data acquired by the acquisition means.

The information processing apparatus may further include a memory, which may store a program for causing the at least one processor to carry out the acquisition process and the generation process. The program may be stored in a non-transitory tangible computer-readable storage medium.

In addition, the whole or part of the example embodiments disclosed above further can also be expressed as follows.

An information processing apparatus including at least one processor, the at least one processor carrying out: an acquisition process for acquiring reference data regarding a reference water distribution plan; and a determination process for determining, by inverse reinforcement learning that refers to the reference data, a cost function which is used for an optimization problem for generating an operation plan regarding a target water distribution plan.

The information processing apparatus may further include a memory, which may store a program for causing the at least one processor to carry out the acquisition process and the determination process. The program may be stored in a non-transitory tangible computer-readable storage medium.

### REFERENCE SIGNS LIST

1, 1A, 2 Information processing apparatus
S10, S2 Information processing method
10A Control section
11, 21 Acquisition section
12 Generation section
20A Storage section
22 Decision section
30A Communication section
40A Input/output section

What is claimed is:

1. An information processing apparatus comprising at least one processor, the at least one processor carrying out:
an acquisition process for acquiring target data regarding a target water distribution plan; and
a generation process for generating an operation plan regarding the target water distribution plan by solving an optimization problem that uses
(i) a cost function determined by inverse reinforcement learning which uses reference data regarding a reference water distribution plan and
(ii) the target data acquired in the acquisition process.

2. The information processing apparatus according to claim 1, wherein
the cost function includes cost terms including variables corresponding to respective items included in the reference data, and
in the generation process, the at least one processor generates the operation plan regarding the target water distribution plan by solving the optimization problem which uses the cost function, in which the target data acquired by in the acquisition process is regarded as a fixed variable, and in which a variable that is among the variables included in the cost terms included in the cost function and that is different from the fixed variable is regarded as a manipulated variable.

3. The information processing apparatus according to claim 1, wherein
the target data includes information indicative of a state of a target waterworks infrastructure.

4. The information processing apparatus according to claim 3, wherein
the target data includes information pertaining to at least one selected from the group consisting of a pump, a water distribution network, a water pipeline, and a demand point in the target waterworks infrastructure.

5. The information processing apparatus according to claim 3, wherein
the operation plan generated in the generation process includes information pertaining to an operation pattern of a pump in the target waterworks infrastructure.

6. The information processing apparatus according to claim 3, wherein
the operation plan generated in the generation process includes information pertaining to personnel involved in the target waterworks infrastructure.

7. The information processing apparatus according to claim 1, wherein
in the acquisition process, the at least one processor acquires the reference data,
the at least one processor further carrying out
a determination process for determining the cost function by inverse reinforcement learning that refers to the reference data.

8. The information processing apparatus according to claim 7, wherein
the reference data includes
information pertaining to at least one selected from the group consisting of a pump, a water distribution network, a water pipeline, and a demand point in a reference waterworks infrastructure, and
information pertaining to at least one selected from the group consisting of an operation pattern of the pump and personnel in the reference waterworks infrastructure.

9. An information processing apparatus comprising at least one processor, the at least one processor carrying out:
an acquisition process for acquiring reference data regarding a reference water distribution plan; and
a determination process for determining, by inverse reinforcement learning that refers to the reference data, a cost function which is used for an optimization problem for generating an operation plan regarding a target water distribution plan.

10. An information processing method comprising:
acquiring target data regarding a target water distribution plan; and
generating an operation plan regarding the target water distribution plan by solving an optimization problem that uses
(i) a cost function determined by inverse reinforcement learning which uses reference data regarding a reference water distribution plan and
(ii) the acquired target data.

11. (canceled)

12. A non-transitory computer-readable storage medium storing therein a program for causing a computer to function as the information processing apparatus according to claim 1, the program causing the computer to carry out the acquisition process and the generation process.

13. A non-transitory computer-readable storage medium storing therein a program for causing a computer to function as the information processing apparatus according to claim 1, the program causing the computer to carry out the acquisition process and the determination process.
